(19) United States
(12) Patent Application Publication
(10) Pub. No.: US 2014/0232377 A1
(43) Pub. Date: Aug. 21, 2014

(54) METHOD AND ASSEMBLY FOR DETERMINING THE ROTATIONAL SPEED OF FERROMAGNETIC COMPONENTS

(71) Applicants: Carl Udo Maier, Stuttgart (DE); Jochen Ostermaier, Erlangen (DE)

(72) Inventors: Carl Udo Maier, Stuttgart (DE); Jochen Ostermaier, Erlangen (DE)

(73) Assignee: Siemens Aktiengesellschaft, Munchen (DE)

(21) Appl. No.: 14/348,336

(22) PCT Filed: Sep. 5, 2012
(86) PCT No.: PCT/EP2012/067322

§ 371 Date: Mar. 28, 2014

(30) Foreign Application Priority Data
Sep. 30, 2011 (DE) 10 2011 083 857.0

(51) Int. Cl. G01D 5/14

(52) U.S. Cl. CPC G01D 5/14
USPC 324/207.13

(57) ABSTRACT

A method for determining the rotational speed of ferromagnetic disks via the detection of permeability changes in dependence on radially directed forces in the disk includes orienting, for the measurement, at least one contactless-operating magneto-elastic sensor toward a face of the ferromagnetic disk to be measured, for detecting permeability changes in the case of occurring radial forces, and for calculating the radial forces from the permeability changes. The primary use is in the field of contactless determining data of rotating components.

The invention relates to a method and a sensor arrangement for determining the rotational speed and further parameters of ferromagnetic, rotating components, in particular disks or shafts. Furthermore, an assembly is described for detecting stresses in rotating, ferromagnetic disks.

By virtue of radially directed forces when accelerating or braking, damage may occur to rotating disks such as for instance disk flywheels, brake disks or similar rapidly rotating components. In such cases the knowledge of the rotational frequency or better still the knowledge of the occurring forces in the disk is very helpful. This knowledge allows the periphery in which damage occurs to be outlined. Furthermore, a monitoring, regulation or optimization of the system can also take place.

In order to determine the angular or rotational speed on disks, markers have been used up to now on the disks, which can be read out by suitable sensors. The speed can consequently be calculated on the basis of the frequency of passing markers.

The forces produced during the rotation can however not be measured with such systems.

Expansion measuring strips/DMS offer the possibility of determining forces in a workpiece by way of a specific method. This is however associated with the disadvantage that a DMS is glued to the disk and sensor data has to be collected by way of a transponder. This method only allows for a rough determination of the rotational speed, which does not respond rapidly to changes.

The object underlying the invention is to provide a method and an arrangement, as a result of which, without making adjustments to the measuring object, the rotational speed and/or the speed of rotating parts, such as disks, can be measured or calculated.

This object is achieved by means of the respective feature combination of an independently formulated claim.

The knowledge underlying the invention is that a contactless-operating magnetoelastic force sensor is positioned on the face of a ferromagnetic disk to be measured or on a component and is oriented in parallel with respect to its axis of rotation, wherein the rotational speed is measured from measurements of the permeability changes in the disk. The highest sensitivity of the sensor is set as far as possible such that radial forces are measured.

By rotating the disk, radial forces occur, which can be detected by the force sensor. These forces may be centrifugal or centripedal forces for instance. The sensor is advantageously placed in the border area of the disk, wherein the largest forces occur on account of the high velocity of circulation. The rotational speed can be calculated from the extent of the measured force.

Since this measurement is not essentially reliant on markers on the measuring object, it can also take place continuously with a high resolution. Small fluctuations in the case of high rotational speeds can thus be identified.

The system is thus in a position to detect rotational vibrations.

If an additional magneto-elastic sensor is used, which is likewise aligned in parallel with the axis of rotation and is, simultaneously with the first sensor, directed toward the face of a rotating disk with a spacing, additional further forces such as braking or accelerating forces can be measured directly or by way of a result thereof. This requires the alignment of the primary sensitivity of the additional magnetoelastic sensor to be changed relative to the at least one sensor, such as angled, rotated or offset. The adjustment can take place by adjusting the sensor head of the additional magnetoelastic sensor.

On account of so-called “frozen” stresses in ferromagnetic materials, caused by the manufacturing process, the current angular position of the disk can be concluded continuously.

If the disk is in some instances not made from ferromagnetic material, a ferromagnetic layer can be applied for instance. If a continuous measurement is not required, the ferromagnetic layer material can be applied only partially.

An exemplary embodiment is described below with the aid of the appended figures.

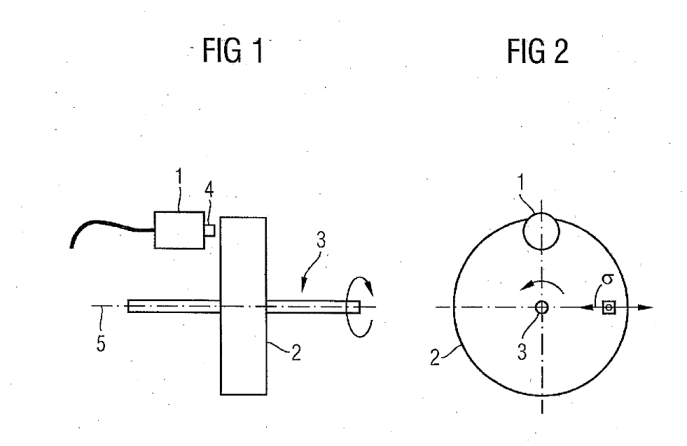

FIG. 1 shows a system for detecting a rotational frequency with the aid of stresses occurring radially in the workpiece or the disk 2,

FIG. 2 shows a representation according to FIG. 1 in the direction of the shaft 3.

The disk with its face is shown over a large surface, the magnetoelastic sensor 1 is positioned on the outer periphery of the disk 2 and aligned in parallel with the axis of rotation 5. A shaft 3 and the forces a occurring in the component or in the disk 2 are shown, the evaluation of which can be related back to the rotational speed of the disk. The magnetoelastic sensor 1 has an adjustable sensor head 4.

The permeability of ferromagnetic materials is influenced by mechanical stresses. This physical effect, which is known as magnetoelastic effect, can be used to measure torques in a rotating object. In such cases a torque generates stresses in the rotating object. The detection of torques by means of magnetoelastic sensors is characterized by high accuracy, there being no need either for post-calibration or for the approach to reference markers.

A magnetoelastic torque sensor, which is used to measure the torque of drive shafts, is known for instance from DE 10 2009 008 074 A1. In this document, a measuring arrangement for detecting torques of a shaft is described, which includes a torque sensor positioned at a predetermined spacing from the surface of the shaft.

In order to measure torques on shafts transmitting force in machines, at least one electromagnetic coil is arranged in a contactless manner at a small distance from the surface of the shaft, said coil responding to the change in permeability in a ferromagnetic layer on the shaft or on an intrinsically ferromagnetic shaft with a signal change. To this end, the shaft must be exposed to torsion stresses.

The magnetoelastic torque sensor must be arranged along the shaft between a driving torque and the reaction torque operating in opposition thereto.

A sensor or sensor system according to the invention allows for rotational frequencies and forces to be measured without changing the measuring object, such as occur for instance when braking or accelerating. The contactless measurement can advantageously also be executed continuously. In such cases this need not be encoded on the measuring object or otherwise adjusted. Furthermore, a rapidly rotating disk such as for instance a flywheel can be used and monitored for energy storage purposes.

On account of the contactless measuring principle, the presented system is suited to retrofitting on existing systems. A rotational frequency can also be calculated from other parameters. A magnetoelastic sensor 1, which performs a measurement on a disk rotating at a high rotational frequency, can determine radial forces at specific positions or record the change thereof and determine further parameters therefrom.

For this reason, a method or assembly according to the invention can generally be used to optimize and monitor disks. On account of the contactless measuring principle, this system is suited to multifunctional use on existing systems.

A statement can be made in particular relating to a remaining service life of a component or a machine. Furthermore, the decision can be made with respect to emergency shut-down, before greater damage occurs.

Furthermore, an angular position can be determined with the aid of the frozen stresses in a disk. Frozen stresses, which generally provide interference signals, can be used in this case to determine the angular position of the disk. Such a system may indicate its essential advantages in the case of high rotational frequencies.

1-10. (canceled)

11. A method for determining a rotational speed of a ferromagnetic component, comprising:
aligning at least one contactless-operating magnetoelastic sensor toward a face of the ferromagnetic component parallel with an axis of rotation of the ferromagnetic component,
determining radial forces generated by a rotation of the ferromagnetic component by measuring with the at least one magnetoelastic sensor permeability changes in the ferromagnetic component, and
calculating a rotational speed of the ferromagnetic component from a magnitude of the determined radial forces.

12. The method of claim 11, wherein the at least one magnetoelastic sensor is positioned in a radially outer edge region of the ferromagnetic component.

13. The method of claim 11, wherein at least one additional magnetoelastic sensor is used, which is directed in conjunction with the first sensor toward the face of the ferromagnetic component and is aligned such that a sensitivity of the at least one additional magnetoelastic sensor is set at a specific angle relative to a sensitivity of the at least one magnetoelastic sensor.

14. The method of claim 11, further comprising at least one of measuring and calculating acceleration forces on the rotating ferromagnetic component.

15. The method of claim 11, wherein the ferromagnetic component is provided at least partially with a ferromagnetic layer.

16. A sensor arrangement for detecting stress in a rotating, ferromagnetic component, comprising:
at least one magnetoelastic sensor aligned toward a face of the ferromagnetic component parallel with an axis of rotation of the ferromagnetic component, wherein the sensor arrangement is configured to
determine radial forces generated by a rotation of the ferromagnetic component by measuring with the at least one magnetoelastic sensor permeability changes in the ferromagnetic component, and
calculate a rotational speed of the ferromagnetic component from a magnitude of the determined radial forces.

17. The sensor arrangement of claim 16, wherein the ferromagnetic component is constructed as a disk or a shaft.

18. The sensor arrangement of claim 16, wherein the permeability changes are measured on a component or a disk rotating on a shaft.

19. The sensor arrangement of claim 16, wherein the at least one magnetoelastic sensor is positioned on components selected from disk flywheels, flywheels, and brake disks for monitoring these components.
